(19) United States
(12) Patent Application Publication
(10) Pub. No.: US 2021/0206192 A1
(43) Pub. Date: Jul. 8, 2021

(54) METHOD OF FORMING MICROIMAGE ELEMENTS

(71) Applicant: DE LA RUE INTERNATIONAL LIMITED, Basingstoke, Hampshire (GB)

(72) Inventor: John GODFREY, London (GB)

(73) Assignee: DE LA RUE INTERNATIONAL LIMITED, Basingstoke, Hampshire (GB)

(21) Appl. No.: 16/650,289

(22) PCT Filed: Sep. 26, 2018
(86) PCT No.: PCT/GB2018/000128

§ 371 Date: Mar. 24, 2020

(30) Foreign Application Priority Data
Sep. 26, 2017 (GB) 1715550.8

(51) Int. Cl. B42D 25/29; B42D 25/342; B42D 25/351; B42D 25/45

(52) U.S. Cl. CPC B42D 25/29; B42D 25/45; B42D 25/351; B42D 25/342

(57) ABSTRACT

A method of forming an array of microimage elements that vary in their material composition is provided. The method comprises: applying a first region of a layer of a first material to a surface of a first material carrier; applying a second region of a layer of a second material, different from the first material, to a surface of a second material carrier; blending together the first and second regions of the layers of first and second material such that a blended region of the layers of first and second material exhibits a gradual change in relative concentration of the first and second materials along a first direction, the step of blending together the first and second regions of the layers of first and second material comprising bringing a first blending surface into contact with the first material on the surface of the first material carrier and moving the first blending surface relative to the surface of the first material carrier along a direction corresponding to the first direction to spread the layer of first material along the direction corresponding to the first direction, and bringing a second blending surface into contact with the second material on the second material carrier and moving the second blending surface relative to the surface of the second material carrier along a direction corresponding to the first direction to spread the layer of second material along the direction corresponding to the first direction; bringing the blended layers of first and second material in the blended region into contact with a patterned material carrier, the surface of the patterned material carrier defining a pattern corresponding to the array of microimage elements, the patterned material carrier selectively removing the first and second material in at least the blended region in accordance with the pattern; and transferring the blended layers of first and second material defining the array of microimage elements on to a support layer.

### FIELD OF THE INVENTION

The present invention relates to a method of forming microimage elements. Microimage elements are commonly used in the formation of security devices, in particular for use in security documents such as banknotes, identity documents, passports, certificates and the like. The present invention also relates to methods of manufacturing security devices involving forming microimage elements.

### DESCRIPTION OF THE RELATED ART

To prevent counterfeiting and enable authenticity to be checked, security documents are typically provided with one or more security devices which are difficult or impossible to replicate accurately with commonly available means, particularly photocopiers, scanners or commercial printers.

Many conventional security devices utilise microimage elements, which are typically elements, such as characters, icons or image portions, at a scale that requires magnification to distinguish with the naked eye. That is, microimage elements are elements that have a smallest lateral dimension on the micron scale and typically collectively contribute to the presentation of a visible image. Microimage elements may be used on their own, for providing a means of verification by close inspection with separate magnifying means, or may be used in conjunction with an array of sampling elements, such as an array of microlenses, to produce complex and secure optical effects. In all cases, microimage elements improve security since they are difficult to replicate with commonly available means, particularly photocopiers, scanners or commercial printers. In particular, such means are typically not capable of accurately resolving and copying the microimage elements, and then not capable of forming replica versions of the microimage elements at the necessary scale. Additionally, microimage elements that are used in conjunction with an array of focussing elements may produce an optically variable effect, meaning that the appearance of the device is different at different angles of view. Such devices are particularly effective since direct copies (e.g. photocopies) will not produce the optically variable effect and hence can be readily distinguished from genuine devices. Examples of security devices that use a combination of microimage elements and focussing elements to produce an optically variable effect include devices moiré magnifier devices, integral imaging devices and so-called lenticular devices.

Several aspects of the invention involve the provision of a microimage element array for positioning approximately in the focal plane of a sampling element array, in particular an array of focussing elements, such that the focussing element array exhibits an image based on the microimage element array. This focussed image may preferably be optically variable and could for example be based on any of the mechanisms detailed below. It should be appreciated that in all aspects of the invention the microimage array could be configured for providing any one or more of these effects, unless otherwise specified.

Moiré magnifier devices (examples of which are described in EP-A-1695121, WO-A-94/27254, WO-A-2011/107782 and WO2011/107783) make use of an array of focussing elements (such as lenses or mirrors) and a corresponding array of microimages, wherein the pitches of the focussing elements and the array of microimages and/or their relative locations are mismatched with the array of focussing elements such that a magnified version of the microimages is generated due to the moiré effect. Each microimage is a complete, miniature version of the image which is ultimately observed, and the array of focussing elements acts to select and magnify a small portion of each underlying microimage, which portions are combined by the human eye such that the whole, magnified image is visualised. This mechanism is sometimes referred to as “synthetic magnification”. The magnified array appears to move relative to the device upon tilting and can be configured to appear above or below the surface of the device itself. The degree of magnification depends, inter alia, on the degree of pitch mismatch and/or angular mismatch between the focussing element array and the microimage array.

Integral imaging devices are similar to moiré magnifier devices in that an array of microimages is provided under a corresponding array of lenses, each microimage being a miniature version of the image to be displayed. However here there is no mismatch between the lenses and the microimages. Instead a visual effect is created by arranging for each microimage to be a view of the same object but from a different viewpoint. When the device is tilted, different portions of the images are magnified by the lenses such that the impression of a three-dimensional image is given.

“Hybrid” devices also exist which combine features of moiré magnification devices with those of integral imaging devices. In a “pure” moiré magnification device, the microimages forming the array will generally be identical to one another. Likewise in a “pure” integral imaging device there will be no mismatch between the arrays, as described above. A “hybrid” moiré magnification/integral imaging device utilises an array of microimages which differ slightly from one another, showing different views of an object, as in an integral imaging device. However, as in a moiré magnification device there is a mismatch between the focussing element array and the microimage array, resulting in a synthetically magnified version of the microimage array, due to the moiré effect, the magnified microimages having a three-dimensional appearance. Since the visual effect is a result of the moiré effect, such hybrid devices are considered a subset of moiré magnification devices for the purposes of the present disclosure. In general, therefore, the microimages provided in a moiré magnification device should be substantially identical in the sense that they are either exactly the same as one another (pure moiré magnifiers) or show the same object/scene but from different viewpoints (hybrid devices).

Moiré magnifiers, integral imaging devices and hybrid devices can all be configured to operate in just one dimension (e.g. utilising cylindrical lenses) or in two dimensions (e.g. comprising a 2D array of spherical or aspherical lenses).

Lenticular devices on the other hand do not rely upon magnification, synthetic or otherwise. An array of sampling or focussing elements, typically cylindrical lenses, overlies a corresponding array of image sections, or “slices”, each of which depicts only a portion of an image which is to be displayed and each of which typically has a width on the micron scale. Image slices from two or more different images are interleaved and, when viewed through the sampling or focussing elements, at each viewing angle, only selected image slices will be directed towards the viewer. In this way, different composite images can be viewed at different angles. Some examples of lenticular devices are described in U.S. Pat. No. 4,892,336, WO-A-2011/051669, WO-A-2011051670, WO-A-2012/027779 and U.S. Pat. No. 6,856,462. More recently, two-dimensional lenticular devices have also been developed and examples of these are disclosed in WO-A-2015/011493 and WO-A-2015/011494. Lenticular devices have the advantage that different images can be displayed at different viewing angles, giving rise to the possibility of animation and other striking visual effects which are not possible using the moiré magnifier or integral imaging techniques.

As counterfeiting techniques improve, there is a need to further improve methods of forming arrays of microimage elements so that the above described devices can be made more secure and difficult to convincingly counterfeit. It is an object of the present invention to address this need.

### SUMMARY OF THE INVENTION

According to a first aspect of the present invention, there is provided a method of forming an array of microimage elements that vary in their material composition, the method comprising: applying a first region of a layer of a first material to a surface of a first material carrier; applying a second region of a layer of a second material, different from the first material, to a surface of a second material carrier; blending together the first and second regions of the layers of first and second material such that a blended region of the layers of first and second material exhibits a gradual change in relative concentration of the first and second materials along a first direction, the step of blending together the first and second regions of the layers of first and second material comprising bringing a first blending surface into contact with the first material on the surface of the first material carrier and moving the first blending surface relative to the surface of the first material carrier along a direction corresponding to the first direction to spread the layer of first material along the direction corresponding to the first direction, and bringing a second blending surface into contact with the second material on the second material carrier and moving the second blending surface relative to the surface of the second material carrier along a direction corresponding to the first direction to spread the layer of second material along the direction corresponding to the first direction; bringing the blended layers of first and second material in the blended region into contact with a patterned material carrier, the surface of the patterned material carrier defining a pattern corresponding to the array of microimage elements, the patterned material carrier selectively removing the first and second material in at least the blended region in accordance with the pattern; and transferring the blended layers of first and second material defining the array of microimage elements on to a support layer.

The present method provides two different materials in two discrete regions, and then blends the materials together such that a gradual change in relative concentration of the two materials is exhibited. Microimage elements then formed using this blended material also exhibit the gradual change in relative concentration of the two materials across the array. The present inventors identified that even though materials cannot easily be controlled directly through application processes on the scale of microimage elements, as may be expected to be required in order to precisely control the material composition of microimage elements, the above described blending process achieves gradual material variation at this small scale, such that microimage elements that each vary slightly from those adjacent can be achieved. This greatly improves security as such variation is typically not possible to reproduce with conventional printing techniques. Using materials of different colours as an example, conventional printing techniques are only able to achieve integral registration of printed elements within a single colour. Therefore, when conventional printing techniques are used to replicate microimage elements which vary gradually in their colour, each print process using a different colour will lack the precise register with other colours necessary to produce a convincing counterfeit. Where colour variation on the scale of individual microimage elements is achieved, an attempt at counterfeiting the array of microimages would essentially require printing each row of microimages in a different colour, e.g. on a different print run.

The present invention uses relative movement between two surfaces to manipulate the first and second materials such that they spread along a first direction. This may be performed while the materials are on the same surface so that the materials spread into one another and blend together by this relative movement, or may be performed while the materials are on separate surfaces such that the materials again spread along the first direction before they are brought together on a common surface such that this spreading of the material produces a gradual variation in the materials where they are coincident. These alternatives are discussed in more detail below.

In many embodiments, a surface of a common material carrier acts as the surface of the first material carrier and the surface of the second material carrier such that the method comprises applying the first region of the layer of the first material to the surface of the common material carrier and applying the second region of the layer of the second material to the surface of the common material carrier, the second region being at least partially offset from the first region along the first direction, and wherein a common blending surface acts as the first blending surface and the second blending surface such that blending together the layers of first and second material comprises bringing the common blending surface into contact with the first and second materials on the surface of the common material carrier and moving the common blending surface relative to the surface of the common material carrier along the first direction, thereby at least partially blending together the first and second materials in the blended region. Here, both materials are blended together while on the same surface. In some embodiments, the first and second materials are completely blended together by relative motion of the common material carrier and the common blending surface, i.e. such that the blended region exhibits the required gradual change in relative concentration of the first and second materials along the first direction. In other embodiments, the materials are only partially blended together and may, for example, be transferred to another surface, at which point a second blending step may be performed to further blend together the materials.

Preferably, bringing the common blending surface into contact with the first and second materials on the surface of the first material carrier and moving the first blending surface relative to the surface of the first material carrier also transfers the layers of first and second material on to the common blending surface. The process of transferring the material may help in the blending process and may also allow the material to be transported to downstream processing means. As mentioned above, the material transferred from the common material carrier may be subject to a subsequent blending process. For example, some embodiments further comprise bringing a further blending surface into contact with the first and second materials on the surface of the common blending surface and moving the further blending surface relative to the common blending surface along the first direction, thereby further blending together the layers of first and second materials in the blended region and preferably also transferring the layers of first and second material on to the common blending surface.

Turning to embodiments in which the first and second materials are not initially provided on a common material carrier, in some embodiments the first material carrier and the second material carrier are separate and the method further comprises transferring the layer of first material and the layer of second material to a surface of a common material carrier such that the first and second layers of material overlap in a region corresponding to the blended material region. That is, the first material and/or second material may separately subjected to manipulation by relative movement of two opposing surfaces such that they separately are spread along what will become the first direction, before they are transferred onto a common material carrier such that the materials overlap, thereby providing the blended region. In some specific embodiments, the surface of the common material carrier acts as the first blending surface and the second blending surface such that the method comprises bringing the surface of common material carrier into contact with the first material on the surface of the first material carrier and moving the surface of common material carrier relative to the surface of the first material carrier and transferring the layer of first material on to the surface of common material carrier, and bringing the surface of common material carrier into contact with the second material on the surface of the second material carrier and transferring the layer of second material on to the surface of common material carrier such that the first and second layers of material overlap in a region corresponding to the blended material region.

As with embodiments in which both materials are initially provided on a common material carrier, complete blending need not be performed in a single step. Some embodiments further comprise bringing a further blending surface into contact with the layers of first and second materials on the surface of the surface of the common material carrier and moving the further blending surface relative to the surface of the common material carrier along the first direction such that the layers of first and second material further blend together in the blended region and preferably such that the layers of first and second material are transferred onto the further blending surface.

In many embodiments, moving the first and/or second blending surface relative to the first and/or second material carrier comprises reciprocating the first and/or second blending surface relative to the first and/or second material carrier along the first direction. Typically the surfaces oscillate along the first direction with respect to one another. This repeated relative motion achieves good blending of the first and second material. In particular, the friction of this movement produces heat, which is good for causing the materials to blend so as to form the gradual change in relative concentration. While preferable, other types of relative movement may achieve the desired blending effect.

Preferably, the or each surface is the surface of a roller and wherein the method is a continuous inline process. That is, one or more, preferably all, of the first material carrier, the second material carrier, the first and second blending surfaces, the further blending surfaces, the common material carrier and common blending surfaces, and the patterned material carrier are rollers. By inline process, it is meant that each of the steps of the method is performed substantially continuously. For example, the first material may be applied to the surface of a first roller in a continuous manner, while the roller rotates. Rotation of the roller may move this material downstream, to where it is blended by contact with a blending surface, while first material continues to be applied in the upstream position. All steps of the method may be performed in such a continuous manner.

In some embodiments, the surface of the first material carrier is the surface of a first roller and the first blending surface is the surface of a second roller, and wherein a central axis of the first roller is parallel to a central axis of the second roller while the surface of the second roller is in contact with the first material on the surface of the first roller, and wherein moving first blending surface relative to the surface of the first material carrier comprises moving at least one of the first and second rollers along their corresponding central axis. Preferably, moving at least one of the first and second rollers along their corresponding central axis comprises oscillating at least one of the first and second rollers along their corresponding central axis. Similarly, where further blending surfaces are used in the form of rollers, the preferable configuration is for rollers to be arranged in parallel and axially moved to effect the movement along the first direction.

After the material is blended, a patterned material carrier is used to selectively remove material in accordance with the pattern. The patterned material carrier may be used to remove material in accordance with a positive or negative of the desired pattern. On the one hand, in some embodiments, transferring the blended layers of first and second material defining the array of microimage elements on to the support layer comprises transferring the blended layers of first and second material removed by the patterned material carrier on to the support layer. This will typically comprise bringing the material carried by the patterned material either directly into contact with the support layer or indirectly via transferring the material onto an offset material carrier. On the other hand, in some embodiments transferring the blended layers of first and second material defining the array of image elements on to the support layer comprises transferring the blended layers of first and second material not removed by the patterned material carrier on to the support layer. That is, the material left behind after the patterned material carrier has removed a portion of the blended material may be transferred directly or indirectly onto the support layer to provide the array of microimage elements.

The surface of the patterned material carrier may comprise an array of elevations and recesses defining the pattern, such that the patterned material carrier selectively removes the first and second material in at least the blended region in accordance with the elevations on the surface of the patterned material carrier. That is, the elevations may be brought into contact with the blended material while the recesses are not in contact with the material such that blended material is transferred only onto elevations. In other embodiments, the surface of the patterned material carrier may comprise a coating defining the pattern and wherein the patterned material carrier selectively removes the first and second material in at least the blended region in accordance with the coating. The coating may, for example, comprise a hydrophilic coating and/or, more typically, a hydrophobic coating. In particular in embodiments comprising a hydrophobic coating, the first and second materials may be first and second oil based inks.

The first and second material defining the array of microimage elements is transferred on to a support layer. Any support layer may be used; however, preferably, the support layer is a transparent support layer. A transparent support layer may act as a spacer layer, spacing the array of microimage elements from a corresponding array of sampling elements. In particular, the support layer may be a security document substrate, such as the transparent substrate of a polymer banknote, or may be a substrate of a security element, such as a security thread, patch or stripe, suitable for incorporation onto or into a security document.

In embodiments in which the first and second materials are applied to the surface of a common material carrier, preferably the first region is substantially adjacent or spaced from the second region on the surface of the common material carrier such that the first and second materials do not overlap on the surface of the first material carrier before blending. Here, relative movement of the surfaces cause the first and second materials to spread into one another to achieve the gradual variation in relative concentration of the two materials.

While preferable, in other embodiments, the first and second materials could partially overlap one another prior to blending.

Preferably the first and second regions of the layers of first and second materials are applied to first and second material carriers using a material application system, the material application system comprising a first material duct arranged to provide the first region of the layer of the first material, and a second material duct arranged to provide the second region of the layer of second material. Ink ducts are commonly used for applying regions of inks, as is the case here, but are not able to apply material in regions on the scale of microimage elements. However, as set out above, the present invention enables material applied by means such as ducts to be blended so as to achieve variation on a much smaller scale, thereby effectively using macro-scale application means to result in an array of microimage elements exhibiting micro-scale material variation. An advantage of material ducts is that they can simultaneously apply regions of material substantially adjacent one another. For example, in some embodiments, a first common material duct acts as the first and second material ducts, the first common material duct comprising a duct divider dividing the first common material duct into the first and second material ducts such that the first and second regions of the layers of first and second material are provided substantially adjacent one another.

Preferably, the first and second materials are first and second inks, although other materials, such as resins, could also be used. Preferably, the first and second materials have different optical properties. For example, the different optical properties may comprise different colours when viewed under visible light. In some cases, the different optical properties may comprise at least one of the first and second materials being fluorescent or phosphorescent. It is foreseen that such materials could be used to provide variation that only becomes apparent under certain lighting conditions. This may be used, for example, to provide a covert effect to what may otherwise appear a conventional security device.

The present method is not limited to the application of only two materials in two regions. Some embodiments comprise applying a third region of a layer of a third material, different from the second material, to a surface of a third material carrier; blending together the second and third layers of material in a second blended region such that the second blended region exhibits a gradual change in relative concentration of the second and third materials along the first direction, the step of blending together the second and third layers of material comprising bringing a third blending surface into contact with the layer of third material on the surface of the first material carrier and moving the third blending surface relative to the surface of the third material carrier along a direction corresponding to the first direction to spread the layer of third material along the direction corresponding to the first direction; bringing the blended layers of first, second and third material in at least the first and second blended regions into contact with the patterned material carrier, the patterned material carrier selectively removing the first, second and third materials in at least the first and second blended regions in accordance with the pattern; and transferring the blended layers of first, second and third materials defining the array of image elements on to the support layer. This essentially extends the method to a third region of a third material such that the blended material exhibits gradual changes between the first, second and third materials along the first direction. The preferable features discussed above with respect to the first and second materials and corresponding surfaces apply equally to the third material and its corresponding processing surfaces. The third material may be the same as the first material, such that the blended material appears to exhibit a gradual change from the first material to the second material and back to the first material.

Preferably, the third region is adjacent or spaced from the second region such that the second and third materials do not overlap on the surface of the common material carrier before blending.

In some embodiments, the first and second blended regions are substantially adjacent one another such that the first and second blended regions exhibit a substantially continuous and gradual change in relative concentration of the first, second and third materials along the first direction. In other embodiments, the blended regions may be spaced from one another, e.g. such that a region comprising substantially only the second material separates the blended regions. The locations of the blended regions can be controlled in particular by the initial positioning of the first and second regions and the degree of relative movement between the surfaces, i.e. larger relative motion resulting in a greater degree of spreading out from the initial position of the material.

A particular advantage of the present invention is that it is possible to provide that at least one, preferably each, microimage element of the array of microimage elements has a smallest lateral dimension smaller than a width of the first and/or second region along the first direction. Indeed, preferably at least one, preferably each, microimage element of the array of microimage elements has a smallest lateral dimension at least ten times smaller, preferably twenty times smaller, more preferably fifty times smaller, than the width of the first and/or second region along the first direction. This takes particular advantage of the fact that material variation is achieved on a scale finer that the scale at which material can be directly controlled during application. This material variation can be on approximately the same scale as the microimage elements themselves.

Preferably, at least one microimage element (preferably a plurality of microimage elements, more preferably each microimage element) of the array of microimage elements has a smallest lateral dimension of 100 μm or less, preferably 50 μm or less. Preferably the microimage element(s) have a width along the first direction of 100 μm or less, preferably 50 μm or less; however it is not essential that the narrow dimension of the microimage elements be aligned with the direction of material variation, i.e. the first direction. Similarly, preferably, the first and/or second regions (and optionally any other regions) have a width along the first direction of 20 mm or less, preferably 10 mm or less, more preferably 5 mm or less, even more preferably 3 mm or less. The use of microimage elements on this scale and first and/or second regions on this scale allows for a particularly preferably rate of change of material composition with respect to the pitch of the microimage element array and thereby makes it very difficult to convincingly counterfeit the resulting security device. In other words, a finer scale of colour variation combined with smaller widths of the microimage elements, results in a security device whose appearance is harder for a counterfeiter to replicate.

Particularly preferably, the array of microimage elements is arranged based on a repeating unit cell, the unit cell defining at least a first and a second microimage element position therewithin, wherein the first microimage element position within the unit cell is assigned to carry a portion of a first image and wherein the second microimage element position within the unit cell is assigned to carry a portion of a second image, whereby each first microimage element position across the array of microimage elements carries a corresponding portion of the first image and each second microimage element position across the array of microimage elements carries a corresponding portion of the second image. It should be appreciated that this microimage element array is an example of one suitable for a lenticular device, and as such each microimage element is a portion (e.g. an individual pixel, a group of pixels, or an image slice) of the corresponding image, not a miniature version of the corresponding image (as would be the case in a moiré magnifier or integral imaging type device). Each set of microimage elements (filling one unit cell) provides one portion of each image and will typically corresponds to one sampling element, e.g. a micro-focussing element, in any final security device. The corresponding sampling element for each unit cell in the final security device will select a microimage element from the set for display to the viewer depending on the viewing angle. The microimage elements all lie in substantially the same plane and the sampling elements will be capable of directing light from any of the microimage elements, depending only on the viewing angle. The selected microimage elements across the array of sampling elements and corresponding unit cells combine to display one of the available images in full, the selected image being dependent on the viewing angle. It will also be understood that, depending on the particular images to be displayed by the device, not all of the image element positions in every cell of the microimage element array will ultimately carry first and/or second material. Some microimage element positions may remain blank, if the corresponding image requires it. In other cases, some microimage element positions may only partially contain first and/or second material, in accordance with the corresponding image portion. In essence, the images will be formed by selected regions of first and/or second material against an empty background. More details of such arrangements of microimage elements may be found in WO-A-2015/011493.

In some embodiments, the array of microimage elements is formed based on the repeating unit cell repeating in two orthogonal directions, and wherein the unit cell defines a two-dimensional set of image element positions. This microimage element array is an example of one suitable for a two-dimensional lenticular device, i.e. in which microimage elements are effectively pixels of corresponding images interlaced in two directions. In other embodiments, the unit cell may repeat in only one direction and, for example, each unit cell may define a set of interlaced microimage slices or strips. Such a microimage element array is an example of one suitable for a one-dimensional lenticular device.

Preferably the array of microimage elements comprises an array of elongate image strips. Such image strips are typically suitable for one-dimensional lenticular devices and, in many cases, will be arranged in accordance with a repeating unit cell, as set out above. These elongate image strips have a width that is on a scale not discernible by the naked eye, but may have a length much larger in scale. Preferably the array of elongate image strips comprises a first set of elongate image strips, each defining a corresponding portion of a first image, and a second set of elongate image strip positions, the first set of elongate image strips being interlaced with the second set of elongate image strip positions. In some embodiments, the second set of elongate image strip positions comprises a second set of elongate image elements, each elongate image strip of the second set of elongate image strips defining a corresponding portion of a second image. In other embodiments, the second set of elongate image strip positions are substantially blank, such that substantially none of the first and second material is provided in the areas corresponding to the second set of elongate image strip positions. Without any further modification, such an array with corresponding sampling elements would exhibit the first image at a first viewing angle and substantially no image at a second viewing angle. This may be advantageous where, for example, it is desirable that the device is transparent at the second viewing angle (e.g. if the array is provided on a transparent support layer). However, as will be set out below, in other cases this “blank” image can be exploited for a separately formed image. As mentioned above, typically the array of elongate image strips are configured for viewing through a corresponding array of sampling elements, such as an array of micro-focussing elements, typically an array of microlenses, such that at a first viewing angle the first set of elongate image elements are displayed and such that at a second viewing angle, different from the first viewing angle, the second set of elongate image strip positions are displayed.

In some embodiments comprising elongate image strips, the elongate image strips extend substantially along the first direction such that the material composition of each elongate image strip is substantially constant along its length and such that the material composition of the elongate image strips changes gradually across the array of elongate image strips. To a counterfeiter, such an array may appear as if it were printed in a number of sequential print runs, and in some cases, each individual strip may appear to have been printed in its own print run. On this basis, convincing counterfeits would be difficult to produce owing to the difficulty of precisely registering separate print processes. In alternative examples the elongate image strips extend substantially perpendicular to the first direction such that each image strip varies gradually in its material composition along its length. In these embodiments, the material variation may not be broken up by any spacing of the image strips and a counterfeiter may find it difficult to replicate this gradual variation convincingly.

The array of microimage elements may comprise a two dimensional array of microimages. Two dimensional arrays include arrays of identical microimages, i.e. small but complete versions of the image to be displayed, such as those suitable for use in moiré magnification devices. It will be appreciated here that identical means identical in shape or outline, as the microimages will vary in their material composition, preferably colour, across the array. Alternatively, each microimage may be a corresponding view of the same object, such as suitable for use in integral imaging devices. The use of microimages that vary gradually in their appearance across the array can produce visually striking effects. For example, in a moiré magnification device, such an array may produce one or more magnified versions of the microimage that vary, for example, in their colour across the device. When the device is tilted, these magnified versions may appear to move across the device, while the colour variation does not move relative to the device, giving the appearance that the magnified versions of the microimages are colour shifting as they move across the device.

In some embodiments, the array of microimage elements is applied to an image element region of the support layer and the method further comprises applying a layer of a secondary material across the image element region of the support layer such that the layer of a secondary material is visible in or through gaps in the array of microimage elements. These embodiments include examples in which the layer of a secondary material is configured to be viewed through the array of microimage elements defined by the blended layers of first and second material. In these cases, the layer of secondary material may extend behind the microimage elements (from the perspective of a viewer) such that the microimage elements act as a mask, revealing the layer of secondary material only in the gaps in the array of microimage elements. These embodiments are particularly advantageous as the layer of secondary material will appear to be precisely registered to the blended layers of first and second material, since it will only be exposed in regions in which the layer of blended first and second material is absent.

In some embodiments, the layer of secondary material is substantially continuous across the image element region. For example, the layer of secondary material may define a background against which the array of microimage elements is viewed. The term background is used here as the layer of secondary material will typically be viewed through the blended layers of first and second material forming the microimage elements. It will be appreciated that the background will not necessarily surround the microimage elements or provide a greater area of the combined appearance when viewing the layer of secondary material through the microimage element array.

While the layer of secondary material may be substantially uniform in its material composition across the image element region, e.g. having a uniform colour, preferably, the layer of secondary material exhibits a gradual change in relative concentration of first and second secondary materials along a second direction. This may be achieved using a similar series of steps used to graduate the material composition of the array of microimage elements. That is, preferably applying the layer of secondary material comprises: applying a first region of a layer of a first secondary material to a surface of a first secondary material carrier; applying a second region of a layer of a second secondary material, different from the first secondary material, to a surface of a second secondary material carrier; blending together the first and second regions of the layers of first and second secondary material such that a secondary blended region of the layers of first and second secondary material exhibits a gradual change in relative concentration of the first and second secondary materials along a second direction, the step of blending together the first and second regions of the layers of first and second secondary material comprising bringing a first secondary blending surface into contact with the first secondary material on the surface of the first secondary material carrier and moving the first secondary blending surface relative to the surface of the first secondary material carrier along a direction corresponding to the second direction to spread the layer of first secondary material along the direction corresponding to the second direction, and bringing a second secondary blending surface into contact with the second secondary material on the second secondary material carrier and moving the second secondary blending surface relative to the surface of the second secondary material carrier along a direction corresponding to the second direction to spread the layer of second secondary material along the direction corresponding to the second direction; and transferring the blended layers of first and second secondary material on to the support layer in the image element region. It will be appreciated that all of the above preferable features discussed in relation to blending of first and second materials apply equally to the blending of first and second secondary materials. Preferably, the second direction is substantially parallel with the first direction on the support layer, i.e. such that all material graduation is along the same direction.

While examples have been described in which the secondary material is applied continuously across the image element region, preferably the layer of secondary material defines a secondary image in the image element region. For example, where the microimage elements are elongate, such as for use in lenticular devices, the secondary image may be overlapped by the image elements such that the secondary image is a consistent background between views while a foreground image provided by the array of image elements changes or disappears owing to the lenticular replay of the different interlaced image element positions. This secondary image may be formed by bringing the blended layers of first and second secondary material in the secondary blended region into contact with a secondary patterned material carrier, the surface of the secondary patterned material carrier defining a second pattern corresponding to the second image, the secondary patterned material carrier selectively removing the first and second secondary material in at least the secondary blended region in accordance with the second pattern; and transferring the blended layers of first and second secondary material defining the secondary image on to the support layer in the image element region.

Alternative examples, further comprise forming a second array of microimage elements that vary in their material composition, wherein the second array of microimage elements comprises a second array of elongate image strips, each image strip of the second array of elongate image strips defining a corresponding portion of a second image, and applying the second array of elongate image strips to the surface of support layer in register with the first array of elongate image strips such that the second array of elongate image strips are substantially located in the second set of elongate image strip positions defined by the first array of elongate image strips. Here, a switch between a first image formed of the first and second materials and a second image provided by the first and second secondary materials may be provided. Providing this second array of microimage elements and applying the second array of microimage elements to the support layer may comprise bringing the blended layers of first and second secondary material in the secondary blended region into contact with a secondary patterned material carrier, the surface of the secondary patterned material carrier defining a second pattern corresponding to the second array of microimage elements, the secondary patterned material carrier selectively removing the first and second secondary material in at least the secondary blended region in accordance with the second pattern; and transferring the blended layers of first and second secondary material defining the second array of microimage elements on to the support layer in the image element region. It has been found that conventional registration techniques are sufficient for providing two such arrays in this manner.

As has been mentioned, the microimage element arrays described above are particularly suited to use in security devices and there, according to a second aspect of the present invention, there is provided a method of manufacturing a security device comprising: forming an array of microimage elements that vary in their material composition in accordance with the above; and applying a corresponding sampling element array over the array of microimage elements. Sampling element arrays include masking grids which are applied spaced from the microimage element array. These masking grids include grids of opaque material that reveal only a portion of the underlying microimage element array and, owing to a parallax effect, reveal different parts of the microimage element array depending on the viewing angle. Other sampling element arrays include arrays of micro-focussing elements, such as arrays of microlenses or micromirrors. For example, where an array of identical microimages is used, the corresponding sampling element array may be a two dimensional array of micro-focussing elements whose pitch is mismatched with respect to the pitch of the array of microimages and/or which is rotated with respect to the array of microimages. Alternatively, where the array of microimage elements are arranged in accordance with a unit cell, the corresponding sampling array may be one which matches the repeat pattern of the unit cell, i.e. one which has the same periodicity as each of the sets of microimage elements. In cases in which the microimage elements are elongate image elements the periodicity of the array of elongate image elements may be the same as or an integral multiple of the periodicity of the sampling element array (along the direction of interlacing of the elongate image elements) such that at a first viewing angle each elongate image element of the first set of elongate image elements is displayed via one or more respective sampling elements of the array of sampling elements and such that at a second viewing angle, different from the first viewing angle, each elongate image element of the second set of elongate image strip positions is displayed via one or more respective sampling elements of the array of sampling elements. Preferably, the array of sampling elements cooperates with the array of microimage elements so as to exhibit at least one image that varies gradually in its appearance (e.g. varies gradually in its colour) along the first direction. It should be noted here that the array of microimage elements may comprise individual microimage elements, each of essentially a single colour, spaced from one another across the array; however, the array of sampling elements, through their sampling effect, will exhibit to a viewer an image with a gradually and preferably continuously varying appearance. This provides an easily recognizable effect that is nonetheless difficult for a counterfeiter to replicate.

Preferably, the array of microimage elements are provided across at least two, preferably at least three, discrete security device regions, wherein preferably, the discrete security device regions are offset (or spaced) from one another along the first direction. By using the array formed as described above to provide discrete device regions, intrinsic register accuracy can be maintained between the device regions. This would allow, for example, lenticular security devices which exhibit a switch from one image channel to another at precisely the same viewing angle. Furthermore, if these regions are offset from one another along the first direction, they may be provided with different colours while maintaining intrinsic register. As mentioned above, the register of different colours is something that is very difficult to counterfeit. In some embodiments, the array of microimage elements is discontinuous between the discrete security device regions, thereby defining a gap in the array of microimage elements. Particularly preferably, the array of microimage elements and the array of sampling elements together exhibit a plurality of images sequentially across the discrete security device regions, wherein preferably the images are exhibited in a sequence that progresses along the first direction. This provides a very striking and easily authenticable security device.

Many of the security devices manufactured in accordance with the above will be integrated security documents, for example into polymer banknotes, and preferably the method further comprises applying an opacifying layer to the support layer. The opacifying layer may be applied to the support layer either before or after transfer of the microimage elements. Preferably, the opacifying layer is applied such that the opacifying layer partially covers the array of microimage elements. In other embodiments, the opacifying layer may be applied so as to define one or more window or half-window regions partially or completely containing the array of microimage elements. Applying an opacifying layer in this way allows the device to be integrated into security articles.

In embodiments in which the security device comprises a plurality of discrete security device regions, preferably the opacifying layer is present between the discrete security device regions. In some cases, the opacifying layer covers the array of microimage elements so as to substantially divide the array of microimage elements into the discrete security device regions. This may therefore give the impression of two security devices, e.g. one exhibiting a red to orange colour variation and the other exhibiting an orange to yellow colour variation. However, the devices will be in perfect register with one another as they are in fact different regions of the same device, and may therefore exhibit coordinated optical variability. For example, where the device is a lenticular device, each device region may exhibit image switches at precisely the same viewing angles. Such precision would be very hard to achieve by counterfeiters attempting to use two discrete devices to replicate the security device described above. Alternatively, the opacifying layer may define two window or half-window regions spaced from one another along the first direction, each window or half-window region completely containing a respective portion of the array of microimage elements.

In some embodiments, the opacifying layer at least partially defines at least one area in which the opacifying layer is absent and through which the array of microimage elements are exposed, the area having the form of an indicium, such as an alphanumeric symbol, character, logo, or image. That is, the microimage element may be selectively revealed by the opacifying layer in accordance with an indicium. This, again, provides another device with enhanced security.

In accordance with a third aspect of the present invention, there is provided a security device comprising: an array of microimage elements formed of at least a first material and a second material, the microimage elements of the array being integrally registered with one another, wherein the material composition of the array of microimage elements varies across the array along a first direction such that the array of microimage elements exhibits a gradual change in relative concentration of the first and second materials along the first direction. The present security device corresponds to one manufactured in accordance with the above described methods and shares the advantages discussed above.

It will be appreciated that many of the features described above as being preferable implementations of the first aspect of the invention have equivalent preferable features that apply equally to this aspect of the invention, some of which are given below.

Preferably, the device further comprises a corresponding array of micro-focussing elements, such as an array of microlenses, located over the array of microimage elements, the array of microimage elements and the corresponding array of micro-focussing elements together exhibiting an optically variable effect. The way in which the lenses may correspond to the microimage elements is described above and applies equally here.

Preferably, the first and second materials are first and second inks, preferably oil based inks, and preferably the first and second materials have different optical properties.

In many embodiments, the array of microimage elements is formed of at least a first material, a second material and a third material, wherein the material composition of the array of microimage elements varies across the array along a first direction such that the array of microimage elements further exhibits a gradual change in relative concentration of the second and third materials along the first direction.

Preferably, the array of microimage elements exhibits the gradual change in relative concentration of the first and second materials along the first direction in a first area of the array of microimage elements and wherein the array of microimage elements exhibits the gradual change in relative concentration of the second and third materials along the first direction in a second area of the array of microimage elements, the first and second areas being adjacent or spaced from one another along the first direction.

In many embodiments, the array of microimage elements is arranged based on a repeating unit cell, the unit cell defining at least a first and a second microimage element position therewithin, wherein the first microimage element position within the unit cell is assigned to carry a portion of a first image and wherein the second microimage element position within the unit cell is assigned to carry a portion of a second image, whereby each first microimage element position across the array of microimage elements carries a corresponding portion of the first image and each second microimage element position across the array of microimage elements carries a corresponding portion of the second image, and wherein the array of micro-focussing elements are arranged on a regular grid having substantially the same periodicity as a periodicity of the repeating unit cell such that, at a first viewing angle, the array of micro-focussing elements displays the first microimage element positions to a viewer, thereby displaying the first image and such that, at a second viewing angle different from the first viewing angle, the array of micro-focussing elements displays the second microimage element positions to a viewer, thereby displaying the second image. In some cases, the array of microimage elements is formed based on the repeating unit cell repeating in two orthogonal directions, and wherein the unit cell defines a two-dimensional set of image element positions.

In particularly preferable embodiments, the array of microimage elements comprises an array of elongate image strips, the array of elongate image strips preferably comprising a first set of elongate image strips, each defining a corresponding portion of a first image, and a second set of elongate image strip positions, the first set of elongate image strips being interlaced with the second set of elongate image strip positions and wherein the array of micro-focussing elements have substantially the same periodicity as a periodicity of the first set of elongate image strips such that, at a first viewing angle, the array of micro-focussing elements displays the first set of elongate image strips to a viewer, thereby displaying the first image. Preferably, the elongate image strips extend substantially along the first direction such that the material composition of each elongate image strip is substantially constant along its length and such that the material composition of the elongate image strips changes gradually across the array of elongate image strips. Alternatively, the elongate image strips may extend substantially perpendicular to the first direction such that each image strip varies gradually in its material composition along its length.

In other embodiments, the array of microimage elements comprises a two dimensional array of microimages.

Preferably, the security device further comprises an opacifying layer partially covering the array of microimage elements, and particularly preferably, the opacifying layer covers the array of microimage elements so as to substantially divide the array of microimage elements into at least two discrete security device regions, wherein preferably, the at least two discrete security device regions are spaced from one another along the first direction.

### BRIEF DESCRIPTION OF THE DRAWINGS

Examples of security devices will now be described with reference to the accompanying drawings, in which:

FIGS. 1A and 1B show, schematically, a system for implementing a method according to a first embodiment of the present invention in cross-section and top view respectively;

FIGS. 2A and 2B show, schematically, a system for implementing a method according to a second embodiment of the present invention in cross-section and top view respectively;

FIG. 3A to 3E show details concerning the formation of a first microimage element array according to the invention;

FIG. 4 shows a second microimage element array according to the invention;

FIG. 5 shows an example of an attempted counterfeit of the first microimage element array according to the invention;

FIG. 6A to 6E show details concerning the formation of a third microimage element array according to the invention;

FIG. 7A to 7F show details concerning the formation of a fourth microimage element array according to the invention;

FIGS. 8A to 8F show details concerning the formation of a fifth microimage element array according to the invention;

FIGS. 9A to 9E show details concerning the formation of a first security document comprising a microimage element array according to the invention;

FIG. 10 shows a second security document comprising a microimage element array according to the invention;

FIG. 11 shows a third security document comprising a microimage element array according to the invention; and

FIG. 12 shows details concerning the formation of a sixth microimage element array according to the invention.

### DETAILED DESCRIPTION

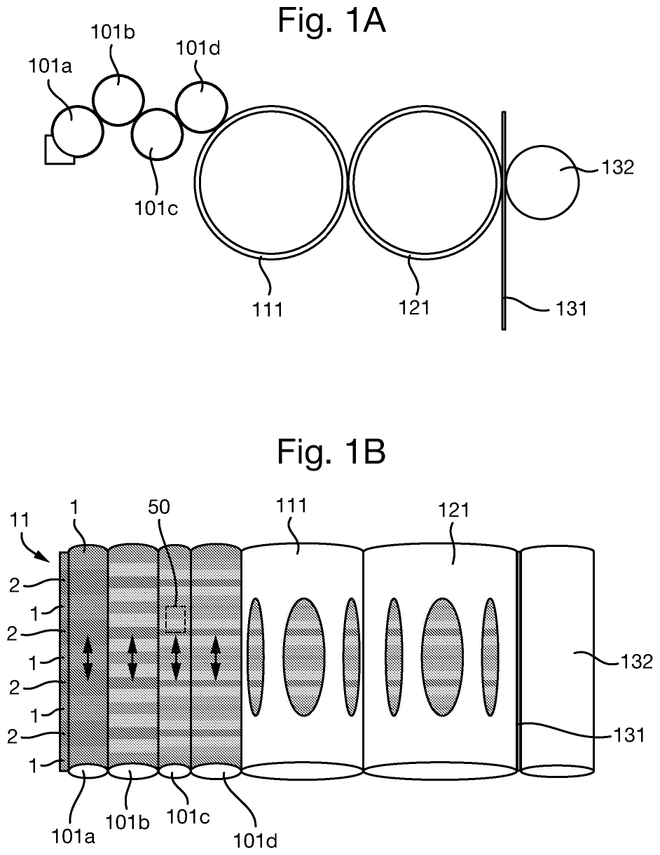

A first method of forming microimage elements will now be described with reference to FIGS. 1A and 1B.

In this method a plurality of cylindrical oscillating ink rollers 101a-101d of substantially equal length and radius are used. Four rollers are shown and described; however, typically more than four will be used. Each roller has a rubber surface and the rollers are arranged such that their axes are parallel with one another. The surface of the first roller 101a contacts the second roller 101b defining a nip therebetween. The surface of the second roller additionally contacts the third roller 101c, defining a further nip. Finally, the surface of the third roller additionally contacts the fourth 101d to define another nip between the rollers. The rollers are driven to oscillate along their central axes by means not shown, the amplitude of the oscillation being selected according to the degree of blending required. Each roller oscillates with a 180° phase difference from the adjacent rollers such that the surfaces of the rollers move relative to one another. Each roller rotates such that the surfaces move at approximately the same speed in the direction of rotation. While rollers 101a and 101d (i.e. the first and last roller) oscillate in this embodiment, in other embodiments these may not oscillate.

Regions of first and second material are continuously applied to the surface of the first roller 101a, as it rotates about its axis, by ink duct 11 which extends substantially along the length of the roller 101a. In this example five regions of first material 1 are applied to the surface of the first roller 101a, separated along the length of the roller (i.e. the first direction) by four regions of second material 2. The first material 1, in this case, is a blue ink, while the second material is a green ink. It must be stressed here that this embodiment describes only nine regions to demonstrate the invention. The Figures are not to scale and in practice, the regions may be much smaller than shown here and more regions of first and second material may be interleaved along the first direction. The ink duct 11 comprises a series of duct dividers for dividing the ink duct into portions corresponding to each of the regions of first and second material 1, 2. In this embodiment, the first roller is oscillating as the first and second materials are applied to its surface, such that first and second materials begin to spread along the first direction as they are applied.

The first roller 101a rotates, bringing the regions of first and second material towards the point at which the first roller 101a contacts the second roller 101b. At this point, the first and second materials, located at the nip between the two rollers, are subject to friction forces between the two oscillating rollers while simultaneously being transferred onto the surface of the second roller 101b. Here, the surface of the second roller acts as a blending surface, and specifically the friction forces and the transferring of material between the surface of the first roller and the surface of the second roller causes the regions of first and second material to blend into one another along the first direction.

The second roller 101b rotates with the received layer of first and second material, bringing the material towards the third roller 101c. Again, the first and second materials proceed to the nip between the two rollers and are subject to friction forces between the two oscillating rollers while simultaneously being transferred onto the surface of the third roller. This is repeated between the third and fourth rollers, such that the fourth roller receives the completely blended layers of material. The material on the fourth roller exhibits a gradual change in relative concentration of the first and second materials along the first direction. Specifically, the material composition varies from almost entirely first material to almost entirely second material and back to almost entirely first material, and so on, along the first direction. It will be appreciated that while four rollers were used here, this is not essential. The method could be performed with two or more rollers, with additional rollers serving to provide a more gradual change in relative concentrations of the two materials.

The fourth roller 101d rotates and brings the layer of blended material into contact with a patterned material carrier 111. The patterned material carrier is a roller arranged with its axis parallel to the fourth roller 101a. In this embodiment, the patterned material carrier has a surface comprising a hydrophobic coating defining the desired microimage element pattern. The first and second materials, blended together on the surface of the fourth roller 101d, are selectively removed from the surface of the fourth roller and transferred onto the patterned material carrier 111 in accordance with the microimage element pattern. In FIG. 1B, the removed material is shown schematically as an elliptical patch of material.

Material remaining on the fourth roller 101d after being brought into contact with the patterned material carrier is then removed by cleaning means, such as a doctoring blade or sacrificial roller (not shown). Similar means may be provided for cleaning the first to third rollers of any residual material left behind after transferring onto a downstream roller, or alternatively the leftover material may be retained on the plate and redistributed over the roller so as to minimise waste of material.

The material carried on the patterned material carrier 111 is then brought into contact with an offset material carrier 121, which again is a parallel roller defining another nip. The offset material carrier 121 receives the material defining the microimage element pattern and transfers the material onto a support layer 131, which in this case is a web of polymer substrate material. Transfer onto the polymer substrate material is effected by passing the polymer substrate material 131 between a nip defined between the offset material carrier 121 and an impression roller 132 so that the polymer material is pressed against the offset material carrier 121.

In this embodiment, the first and second materials are inks. Suitable inks include conventional lithographic inks, preferably oil based inks, and in particular include K+E® process inks sold by Flint Group of Sieglestrasse 25, 70469 Stuttgart, Germany.

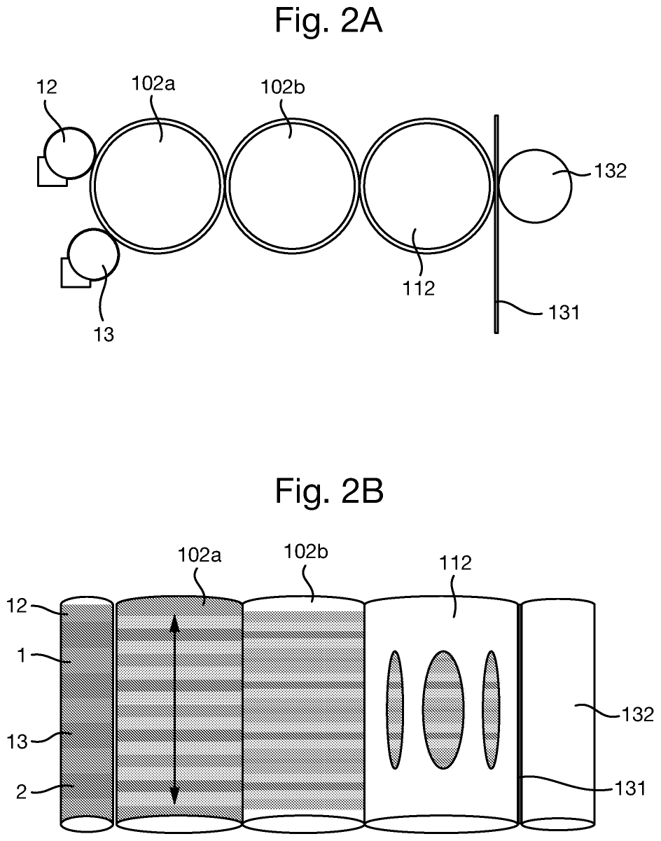

An alternative method of forming microimage elements will now be described with reference to FIGS. 2A and 2B.

In this embodiment, first material 1, again a blue ink, is received on a first patterned anilox roller 12. The first patterned anilox roller is engraved so as to define five raised regions in which the blue ink will be received. Similarly, the second material 2, again a green ink, is received on a second patterned anilox roller 13, the second patterned anilox roller 13 being engraved so as to define four raised regions in which the green ink will be received. The regions defined on the patterned anilox rollers 12, 13 are such that when the materials are transferred onto a common material carrier, the regions of first and second materials alternate along the first direction.

The second patterned anilox roller 13 defines a nip with a first oscillating material carrier, which is an oscillating roller 102a. The oscillating roller 102a is substantially the same length as each of the patterned anilox rollers 12, 13 and is provided such that its axis is parallel with each of the patterned anilox rollers 12, 13. At the nip between the second patterned anilox roller 13 and the oscillating roller 102a, the second material 2 is subjected to friction forces as the oscillating roller 102a moves relative to the second patterned anilox roller 13. The second material 2 is transferred onto the oscillating roller 102a and spreads out along the axis of the roller (i.e. the first direction). The surface of the oscillating roller rotates towards a nip defined between the oscillating roller 102a and the first patterned anilox roller 12, at which point the first material 1 is brought into contact with the surface of the oscillating roller 102a. The first material is transferred onto the oscillating roller 102a and spreads out along the axis of the roller (i.e. the first direction) owing to the frictional force between the surfaces. The result is that the first and second materials are provided on the surface of the oscillating roller 102a and exhibit a gradual change in relative concentration along the first direction owing to the spreading out of those materials along the axis of the roller away from their original application positions.

The oscillating roller 102a rotates further, bringing the material towards a nip defined between the oscillating roller 102a and a non-oscillating offset material carrier 102b, the offset material carrier 102b being another roller disposed parallel with the oscillating roller 102a. At the nip between these two rollers, the material is transferred onto the surface of the offset material carrier 102b, while the first and second materials are further blended together owing to the relative axial movement between of the rollers.

The offset material carrier 102b rotates, bringing the blended material towards patterned material carrier 112. In this embodiment, the patterned material carrier is a flexographic roller. That is, the surface of the roller comprises an array of elevations and recesses defining the pattern. At a nip between the flexographic roller and the offset material carrier 102b, the blended material is transferred onto the elevations on the surface of the flexographic roller 112, such that the flexographic roller receives the first and second materials defining an array of microimage elements. Again, in the Figure, the array of microimage elements is shown schematically as an elliptical patch of blended material.

The blended material carried by the flexographic roller 112 is then transferred onto a polymeric substrate 131, again provided in the form of a web. Transfer onto the polymer substrate material is effected by passing the polymer substrate material 131 between a nip defined between the flexographic roller 112 and an impression roller 132 so that the polymer material is pressed against the flexographic roller 112.

In this embodiment, the first and second materials are again inks. Suitable inks include conventional flexographic inks, preferably aqueous inks or UC curable materials.

An embodiment using UV curable materials could use UV curable polymers employing free radical or cationic UV polymerisation. Examples of free radical systems include photo-crosslinkable acrylate-methacrylate or aromatic vinyl oligomeric resins. Examples of cationic systems include cycloaliphatic epoxides. Hybrid polymer systems can also be employed combining both free radical and cationic UV polymerization. Electron beam curable materials would also be appropriate for use in the presently disclosed methods. Electron beam formulations are similar to UV free radical systems but do not require the presence of free radicals to initiate the curing process. Instead the curing process is initiated by high energy electrons. An exemplary suitable UV curable flexographic ink for use in the presently disclosed methods would be Flexocure Force™ from Flint Group. An exemplary suitable electron beam curable ink would be Photoflex II™ from the Wikoff Color Corporation.

Conventional water based flexographic inks are suitable for this invention but suitable resin systems include carboxymethyl-cellulose, hydroxyethylcellulose, hydroxypropyl-cellulose, hydroxybutylmethylcellulose, poly(C_{I}-C4) alkylene oxides, polyethyleneimine, polyvinyl alcohol, polyvinyl acetate, polyvinylpyrollidone, polyvinyl-oxazolidone and polyacrylamide polymers.

Some examples of microimage element arrays that may be produced in accordance with the above methods will now be described.

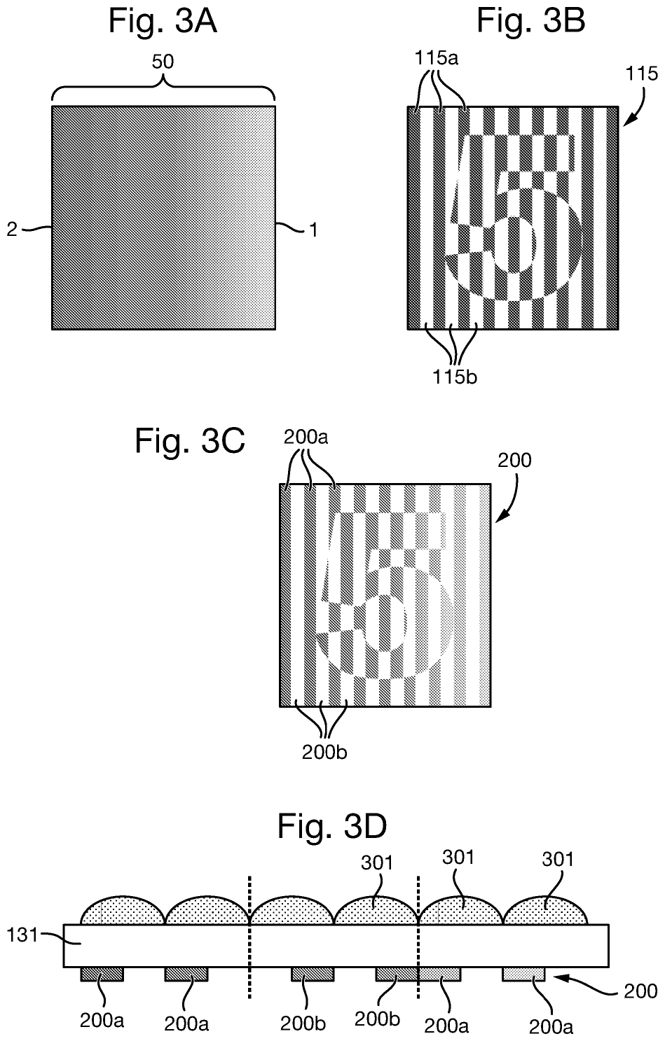

FIGS. 3A to 3F relate to a first microimage element array according to the invention and these will now be described with reference the methods described above.

FIG. 3A shows an area 50 of blended first and second material 1, 2, formed as described above. The area 50 corresponds to the area of material that will subsequently be selectively removed so as to form a first array of microimage elements 200. The blended first and second material exhibits a gradual change from substantially entirely second material 2 on the left-hand side of FIG. 3A to substantially entirely first material 1 on the right-hand side of FIG. 3A.

FIG. 3B shows the pattern 115 in the surface of the patterned material carrier in the area of the patterned material carrier that will be brought into contact with the area 50 of blended first and second material 1, 2. In this Figure, the black regions correspond to the areas of the patterned material carrier that will collect the material and the white regions the areas of the patterned material carrier that will not collect the material. In this embodiment, the pattern 115 formed in the surface of the patterned material carrier defines first and second sets of elongate image elements 115a, 115b, or image strips. The first and second sets of elongate image elements 115a, 115b are interleaved along the first direction, i.e. the direction of gradual colour change. The first set of image strips 115a negatively defines an indicium in the form of a ‘5’. That is, the body of the ‘5’ is provided by the absence of material and is visible against a background provided by the presence of material. The second sets of image strips 115b positively define an indicium in the form of a ‘5’. That is, the body of the ‘5’ is provided by the presence of material and is visible against a background provided by the absence of material. Each microimage element defines a corresponding strip of one of the two images. While in this embodiment, the first and second sets of image strips both define a ‘5’, it is not required that the images defined by the sets of image strips are the same and any two images could be used.

When the pattern 115 in the surface of the patterned material carrier is brought into contact with the area of blended material 50 shown in FIG. 3A, the blended material is received on the patterned material carrier in accordance with the pattern 115 and this arrangement of the blended material is shown in FIG. 3C as an array of coloured microimage elements 200 comprising first and second sets of microimage elements 200a, 200b (corresponding to the first and second sets of elongate image elements 115a, 115b defined by the pattern 115) that exhibit a gradual colour variation along the first direction. Each elongate image element is substantially uniform in colour owing to the interleaving of the image strips along the first direction; however, each elongate image element differs slightly in colour from those image elements adjacent to it.

FIG. 3D shows this array of microimage elements 200 having been transferred onto the polymeric substrate 131 and formed into a lenticular security device. Specifically, the array of microimage elements 200 are provided on one side of the transparent polymeric substrate 131, while a corresponding array of elongate cylindrical lenses 301 are provided on the opposite side of the transparent polymeric substrate 131. Each lens 301 overlaps a corresponding one of the first set of microimage elements 200a and a corresponding one the second set of microimage elements 200b such that, at a first viewing angle, the image strip of the first set is shown and, at a second viewing angle, the image strip of the second set is shown. In this way, the array of lenses cooperate to selectively display the first and second sets of image strips at different viewing angles such that a switch between a positively defined ‘5’ and a negatively defined ‘5’ is exhibited when the security device is tilted. The appearance of the device at the first viewing angle, i.e. when the first set of microimage elements 200a is displayed via the lenses 301, is shown in FIG. 3F, while the appearance at the second viewing angle, i.e. when the second set of microimage elements 200b is displayed via the lenses, is shown in FIG. 3E.

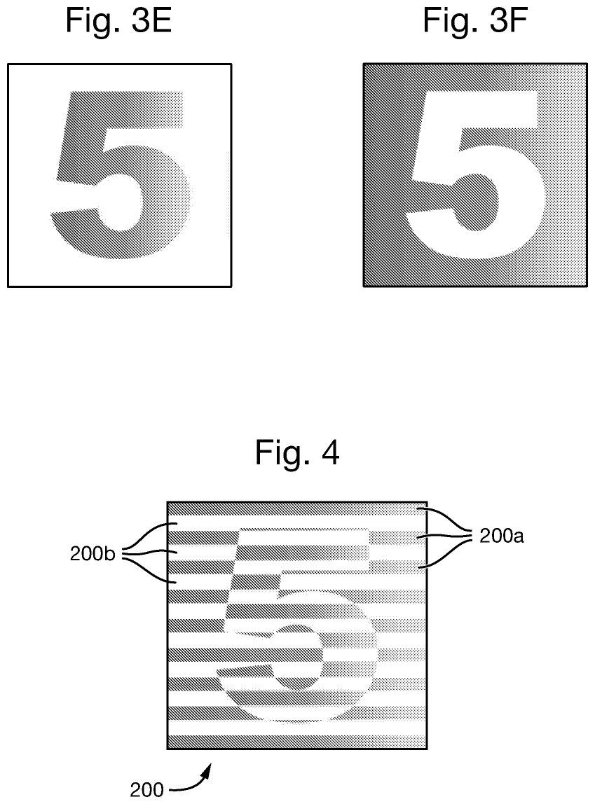

FIG. 4 shows an alternative set of microimage elements in the form of image strips. Here the microimage elements are substantially as described above with respect to FIG. 3, but the first and second sets of elongate image elements 200a, 200b are interleaved along a direction perpendicular to the first direction such that each elongate image strip varies gradually in colour along its length.

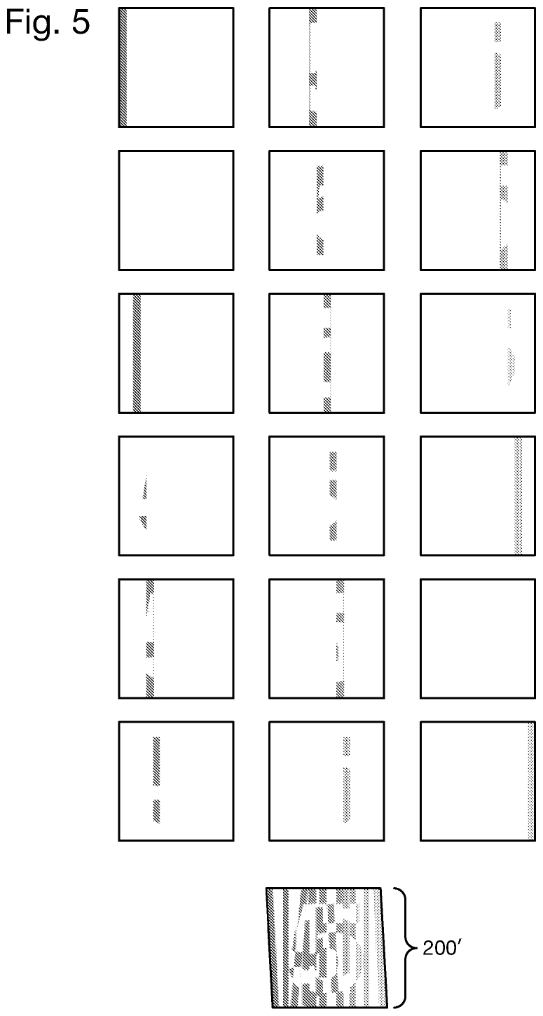

FIG. 5 is an example of an attempted counterfeit 200′ of the array of microimage elements 200 of FIGS. 3A to 3F. FIG. 5 shows the successive printing processes performed for each image strip. Each strip must be printed separately as they are formed in different and unique colours, owing to the gradual variation. Owing to the difficulty of registering successive printing processes with one another, the resulting array of microimage elements, shown at the bottom of FIG. 5, is distorted, with image elements being angularly and laterally offset from their intended location.

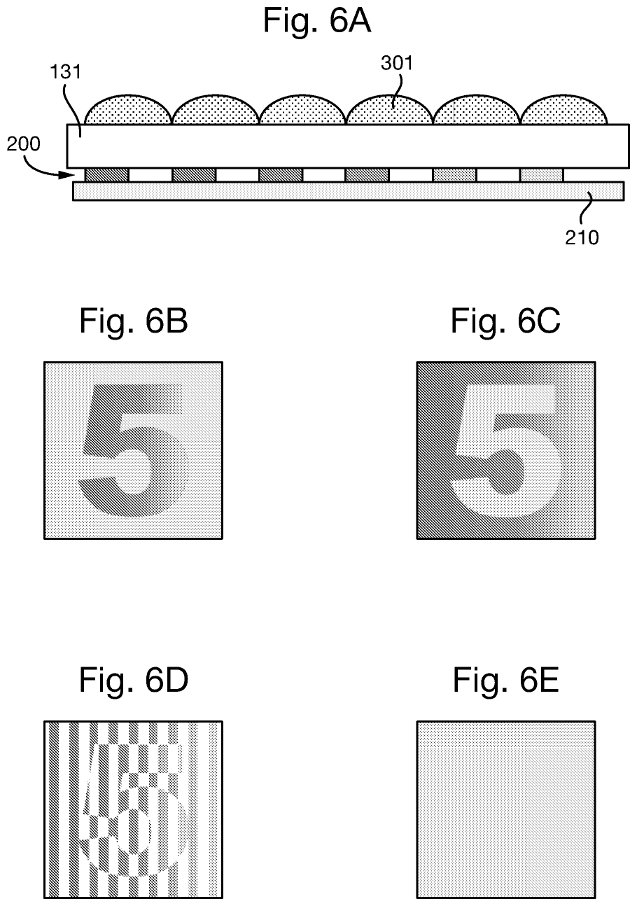

FIGS. 6A to 6E show an alternative security device formed using the microimage element array described above with respect to FIG. 3. This security device is shown in FIG. 6A and is substantially the same as shown in FIG. 3D. That is, an array of microimage elements 200 (shown in FIG. 6D) are provided on one side of the transparent polymeric substrate 131, while a corresponding array of elongate cylindrical lenses 301 are provided on the opposite side of the transparent polymeric substrate 131. Again, each lens 301 overlaps a corresponding one of the first set of microimage elements 200a and a corresponding one the second set of microimage elements 200b such that, at a first viewing angle, the image strip of the first set is shown and, at a second viewing angle, the image strip of the second set is shown. Additionally, the security device is provided with a continuous layer of a secondary material 210 (shown in FIG. 6E), which in this case is a layer of yellow ink. The continuous layer of secondary material is provided over the entire array of image elements 200 such it is only visible through the gaps in the array of microimage elements 200. The result is that the appearance of the device at the first viewing angle, shown in FIG. 6C, is of a yellow ‘5’ against a background that gradually varies from green to blue along the first direction. When the device is tilted to the second viewing angle, such that the second set of image strips 200b are shown, the appearance of the device is of a ‘5’ that varies gradually from green to blue against a uniformly yellow background. This is shown in FIG. 68. Advantageously, since the yellow, secondary material 210 is only visible in the gaps through the array of microimage elements 200, there will be no apparent misregistration between the different colours of the security device. It will be appreciated that, instead of a continuous yellow background, a secondary image could be applied over the array, such as a patterned background, to provide additional complexity to the appearance of the device.

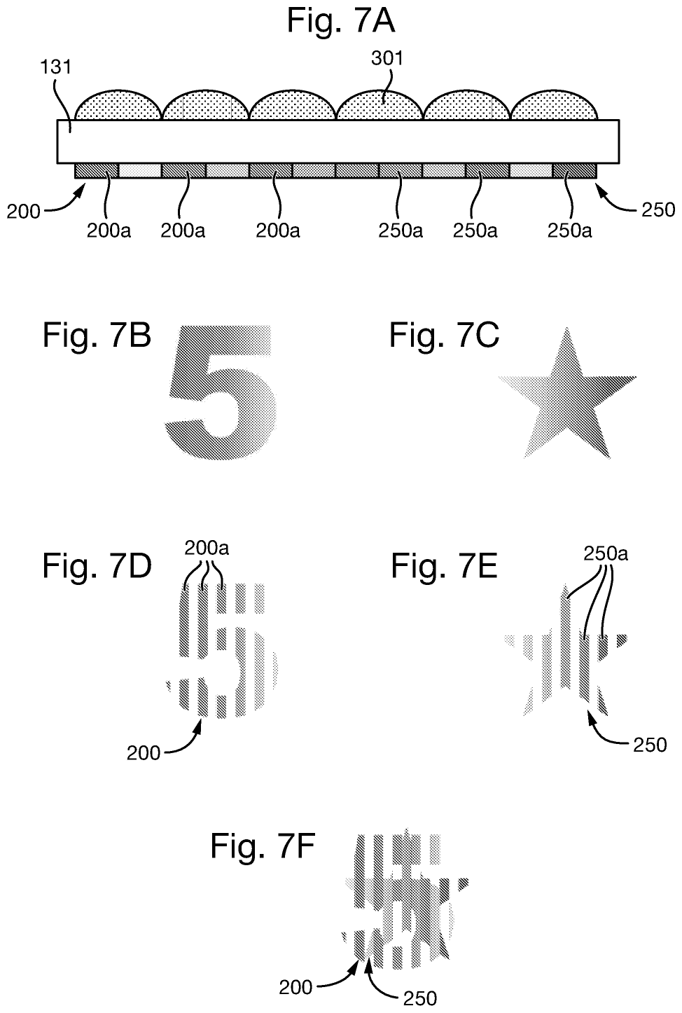

FIGS. 7A to 7F shows another implementation of the present invention. FIG. 7A shows a security device comprising a transparent support layer 131 with an array of elongate cylindrical lenses 301 on one side. On the opposite side, two different arrays of elongate microimage elements are provided. These arrays are shown separately in FIGS. 7D and 7E and in combination in FIG. 7F.

The first array 200, shown in FIG. 7D, is formed substantially in accordance with the method described above, but defines only a first set of elongate image elements 200a. These elongate image elements 200a are interleaved along the first direction with a set of second image elements positions, i.e. with a set of empty image element position that contain no material. The elongate image elements 200a positively define an indicium having the shape of a ‘5’, with each image element being a different strip of the indicium. The second array 250, shown in FIG. 7E, by performing essentially the same series of steps used to produce the first array. The steps are different in that the colours of the materials used are different, i.e. yellow and red inks are used as first and second secondary materials so that a gradual variation between red and yellow is produced along a second direction (in this case, the second direction is the same as the first direction, such that all material variation is along the same direction in the final security device. The steps are also different in that the pattern provided on the patterned material carrier is different, to produce a different image. In this case, the pattern defines an array of elongate image elements 250a that positively define an indicium having the shape of a star. These elongate image elements 250a are interleaved along the second direction with a set of second image elements positions, i.e. with a set of empty image element position that contain no material. The first array 200 and second array 250 are then provided on the same surface of the transparent support layer 131, such that the elongate image elements 250a of the second array 250 are provided in the empty image element positions of the first array 200 and vice versa. It has been found that registration can be controlled to an extent sufficient to provide two arrays in this manner without degrading the appearance of the final security device.

The appearance of the security device at first and second viewing angles is shown in FIGS. 7B and 7C. Specifically, at the first viewing angle, the viewer sees a ‘5’ that varies gradually from blue to green as the lenses display the elongate image elements 200a of the first array 200, while at the second viewing angle, the viewer sees a star that gradually varies from yellow to orange as the lenses display the elongate image elements 250a of the second array 250.

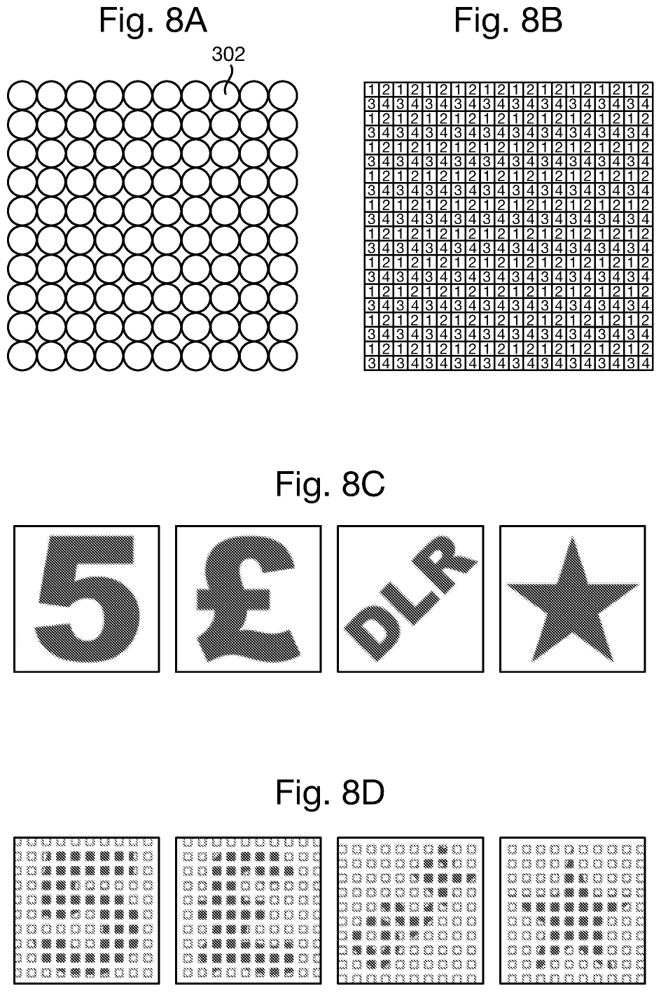

FIGS. 8A to 8G show another implementation of the present invention. Specifically, they show a so-called two-dimensional lenticular device formed with microimage elements that vary in their material composition.

FIG. 8A shows a regular two-dimensional array of spherical lenses 302 that, in use, will be provided on one side of a substantially transparent support layer. FIG. 8B shows a grid formed using a repeating unit cell structure which is used to assign microimage elements from, in this case, four different images to positions beneath each lens. Specifically, under each spherical lens, a microimage element from a first image is provided in a top left position, a microimage element from a second image is provided in a top right position, a microimage element from a third image is provided in a bottom left position and a microimage element from a fourth image is provided in a bottom right position, wherein each microimage element is a portion of the respective image.

FIG. 8C shows the four images to be divided up across the various image element positions. In this case, the images are a ‘5’, a ‘£’, the letters ‘DLR’ and a star. FIG. 8D shows the portions of these images that will be mapped into the various positions of the grid shown in FIG. 8B. Specifically, each top left position will be provided with a corresponding portion of the ‘5’, each top right position will be provided with a corresponding portion of the ‘£’ each bottom left position will be provided with a corresponding portion of the letters ‘DLR’ and each bottom right position will be provided with a corresponding portion of the star symbol.

FIG. 8E shows the grid of FIG. 8B once it has been provided with the corresponding portions of each image forming an interlaced pattern. This pattern represents an interlacing of portions of the four images in two dimensions. The pattern is used as the pattern 115 provided in the pattern support layer in the above described method. The pattern 115 is brought into contact with a corresponding area 50 of blended material to remove an array of microimage elements 200 that vary gradually in their material composition and this is shown in FIG. 8F. FIG. 8G shows the four different images that will be displayed by this security device at corresponding viewing angles. That is, the images are a ‘5’, a ‘£’, the letters ‘DLR’ and a star, each of which varies in colour from green to blue across the security device.

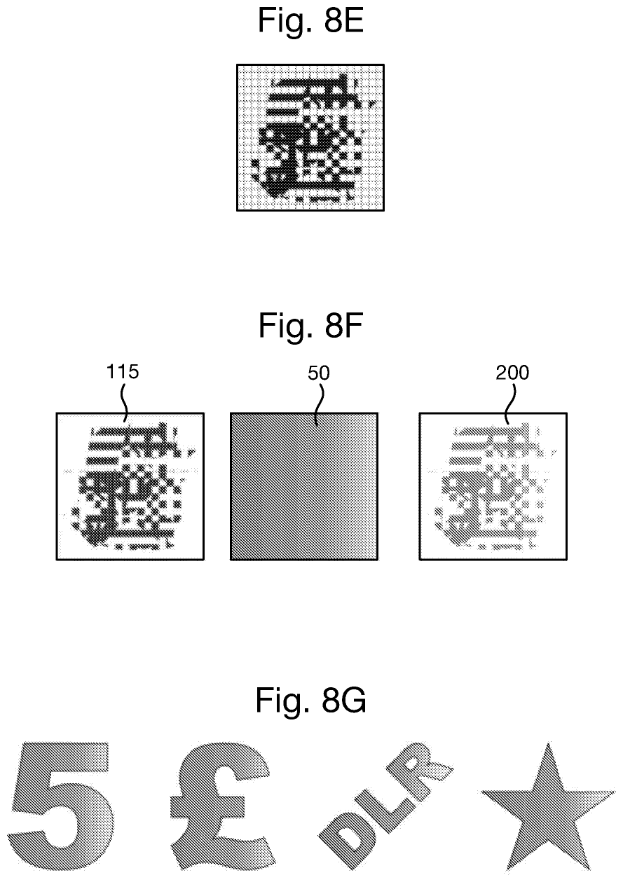

FIGS. 9A to 9E show another implementation of the present invention. Specifically, they show a security document, in this case a banknote 400, integrated with a security device formed using the above method. The security device is formed in a security device region 410, which runs the full length of the short axis of the banknote and extends only partially along the long axis of the banknote to define a stripe region.

FIG. 9D shows an area of blended material that may be formed in accordance with the above method. In this case, the material exhibits a gradual change from pink to yellow. The blended material is blended along a length that corresponds to the height of the banknote 400. FIG. 9E shows a pattern 115 defining an array of elongate microimage elements 115a. In this case, the pattern defines a first set of elongate microimage elements interleaved along the first direction, i.e. along a direction corresponding to the short axis of the banknote 400, with a second set of empty image element positions. The elongate microimage elements, in the final security device, run along the long axis of the banknote and each elongate microimage element of the first set is of the same length, i.e.

extending the width of the security device region 410. The pattern defines the array with three breaks along the interleaving direction so as to separate the image elements into four discrete sub-regions 410a, 410b, 410c, 410d.

FIG. 9C shows the blended material applied to the banknote 400 as the array of elongate microimage elements 200 with an overlapping array of cylindrical lenses 301. The banknote is additionally provided with an opacifying layer 303 applied to both sides of the banknote. The opacifying layer 303 delimits areas of the security device region 410 and specifically delimits regions, on both sides of the banknote, that resemble a flying owl in each of the four sub-regions 410a, 410b, 410c, 410d. When the security device is viewed at a first viewing angle, the array of lenses sample the microimage elements 200a such that, in the first sub-region 410a, the first owl-shaped area not covered in opacifying material appears yellow, in the second sub-region 410b, the second owl-shaped area not covered in opacifying material appears a first shade between yellow and pink, in the third sub-region 410c, the third owl-shaped area not covered in opacifying material appears a second shade between yellow and pink and in the fourth sub-region 410d, the fourth owl-shaped area not covered in opacifying material appears pink. When the banknote is tilted such that the lenses sample the empty image element positions between image elements 200a, each of the owl-shaped areas turns clear, allowing the viewer to see through the banknote. These two different views are visible in FIG. 9A, while the first view is visible enlarged in FIG. 9B. Importantly, as each of the sub-regions 410a, 410b, 410c and 410d are regions of the same microimage element array 200 formed during the same printing process, they will be integrally registered, such that each region switches from coloured to clear at precisely the same viewing angle.

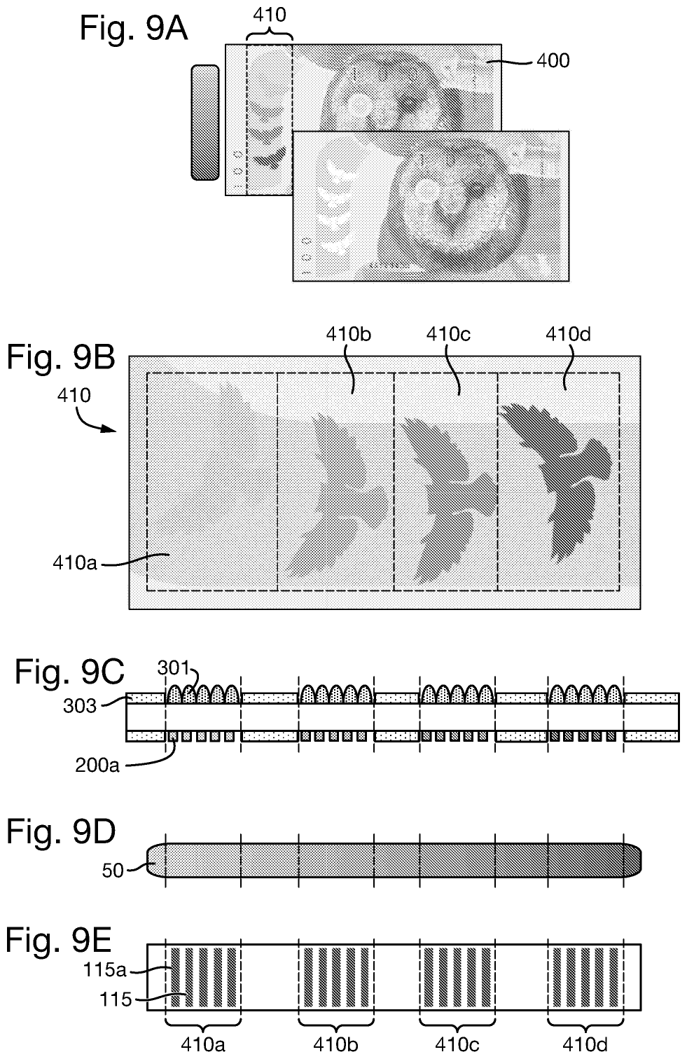

FIG. 10 shows another implementation of the present invention, again as a security device implemented in the same security device region 410 of a banknote 400. Here, the blended material exhibits a gradual change from red to green and back to red along the short axis of the banknote 400. The material is formed into an array 200 of interlaced elongate microimage elements comprising a first and second set of interlaced microimage elements, as described above. The security device is divided into three sub-regions 410a, 410b, 410c by opacifying layers on both sides of the banknote 400. In a first sub-region 410a, which corresponds to a first red area of the blended material, the array 200 comprises the interlaced first and second sets of image elements positively defining a star symbol and a ‘£’ symbol respectively. In a second sub-region 410b, which corresponds to a middle green area of the blended material, the array 200 comprises the interlaced first and second sets of image elements positively defining a ‘£’ symbol and a star symbol respectively. Finally, in a third sub-region 410c, which corresponds to a second red area of the blended material, the array 200 comprises the interlaced first and second sets of image elements positively defining, again, a star symbol and a ‘£’ symbol respectively.

As the banknote of FIG. 10 is tilted between first and second viewing angles, the array of cylindrical lenses switch between sampling the first and second sets of microimage elements. The result is that the banknote exhibits in the first and third sub-regions 410a, 410c a switch from a star symbol to a ‘£’ symbol in red, and in the second sub-region 410b a switch from a ‘£’ symbol to a star symbol in green. Again, as these are formed as a single security device, the switches will occur at precisely the same viewing angle.

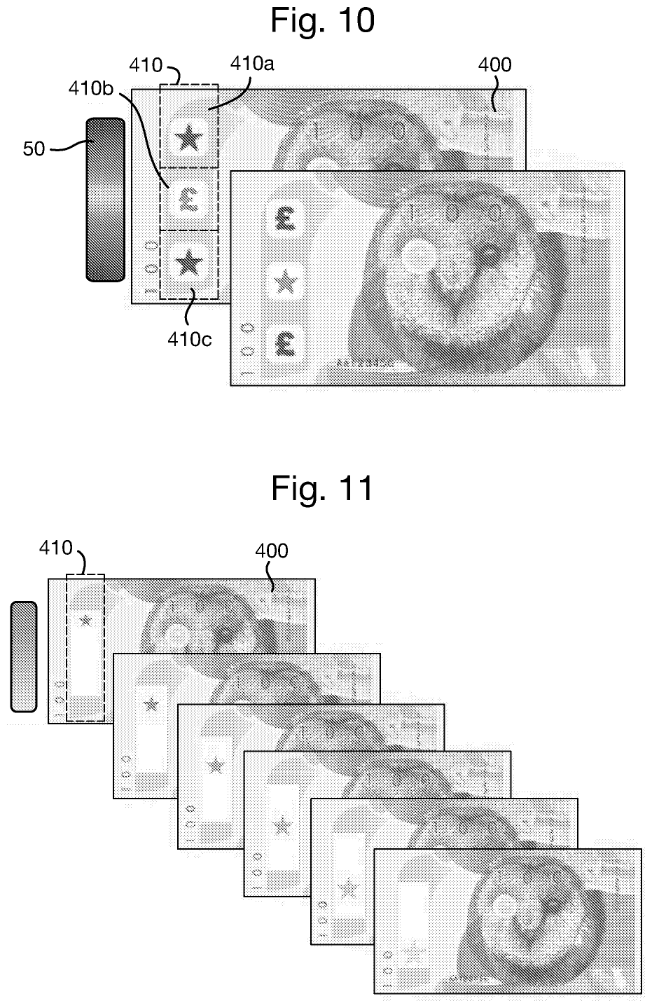

FIG. 11 shows another implementation of the present invention, again as a security device implemented in the same security device region 410 of a banknote 400. Here, the blended material exhibits a gradual change from blue to yellow along the short axis of the banknote 400. In this embodiment, the array of elongate microimage elements are provided as six interlaced sets of microimage elements, such that the security device has six distinct viewing angles. In this embodiment, the each set of image elements defines a star at a different position along the short axis of the banknote. Tilting the banknote changes which of the sets of microimage elements is being sampled by the array of cylindrical lenses such that the banknote displays a star that appears to move along the short axis of the banknote and change colour.

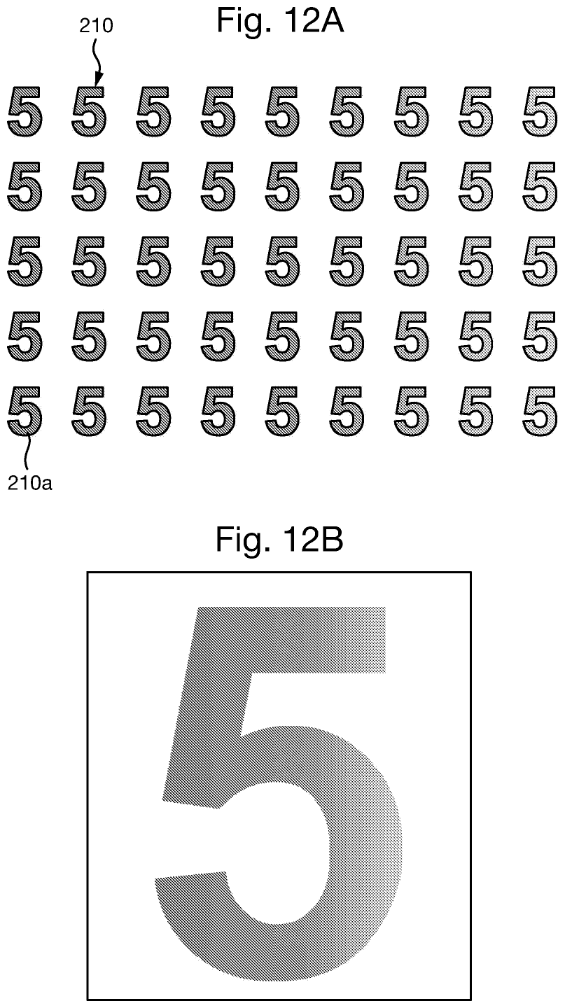

The above embodiments have focussed on lenticular devices; however, the present invention can be used with any type of microimage element array. FIGS. 12A and 12B demonstrate the use of the invention for a moiré magnification device. Specifically, FIG. 12A shows an array 210 of identical microimages 210a, each in the form of a ‘5’. The microimages 210a vary in their colour from green to blue across the microimage array 210. It will be appreciated here that, in practice, the array will have many more microimages than are shown in the Figure. When this array of microimages is used with an array of spherical lenses whose pitch differs from that of the array of microimages, one or more synthetically magnified images are formed. FIG. 12B shows the appearance of a device provided with a lens array that generates a single synthetically magnified version of the microimages. It can be seen here that the synthetically magnified image varies gradually in its colour across the security device, whereas each individual microimage was substantially uniform in colour. Upon tilting this device, the synthetically magnified ‘5’ will appear to move across the security device; however, the colour variation does not move relative to the device, providing the device with a colour shifting appearance.

The above has focussed on application of the microimage element array directly to polymer banknotes so as to incorporate the security device into the banknote, i.e. by providing the sampling array on the opposite surface of the banknote. However, it will be appreciated that security devices of the sorts described above can be incorporated into or applied to any product for which an authenticity check is desirable. In particular, such devices may be applied to or incorporated into documents of value such as banknotes, passports, driving licences, cheques, identification cards etc. The microimage element array and/or the complete security device can either be formed directly on the security document or may be supplied as part of a security article, such as a security thread or patch, which can then be applied to or incorporated into such a document.

Such security articles can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security article may be incorporated into a paper or polymer base substrate so that it is viewable from both sides of the finished security substrate at at least one window of the document. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security device may also be applied to one side of a paper substrate, optionally so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

1-81. (canceled)

82. A method of forming an array of microimage elements that vary in their material composition, the method comprising:
applying a first region of a layer of a first material to a surface of a first material carrier;
applying a second region of a layer of a second material, different from the first material, to a surface of a second material carrier;
blending together the first and second regions of the layers of first and second material such that a blended region of the layers of first and second material exhibits a gradual change in relative concentration of the first and second materials along a first direction, the step of blending together the first and second regions of the layers of first and second material comprising bringing a first blending surface into contact with the first material on the surface of the first material carrier and moving the first blending surface relative to the surface of the first material carrier along a direction corresponding to the first direction to spread the layer of first material along the direction corresponding to the first direction, and bringing a second blending surface into contact with the second material on the second material carrier and moving the second blending surface relative to the surface of the second material carrier along a direction corresponding to the first direction to spread the layer of second material along the direction corresponding to the first direction;
bringing the blended layers of first and second material in the blended region into contact with a patterned material carrier, the surface of the patterned material carrier defining a pattern corresponding to the array of microimage elements, the patterned material carrier selectively removing the first and second material in at least the blended region in accordance with the pattern; and
transferring the blended layers of first and second material defining the array of microimage elements on to a support layer.

83. A method according to claim 82, wherein a surface of a common material carrier acts as the surface of the first material carrier and the surface of the second material carrier such that the method comprises applying the first region of the layer of the first material to the surface of the common material carrier and applying the second region of the layer of the second material to the surface of the common material carrier, the second region being at least partially offset from the first region along the first direction, and wherein a common blending surface acts as the first blending surface and the second blending surface such that blending together the layers of first and second material comprises bringing the common blending surface into contact with the first and second materials on the surface of the common material carrier and moving the common blending surface relative to the surface of the common material carrier along the first direction, thereby at least partially blending together the first and second materials in the blended region.

84. A method according to claim 83, wherein bringing the common blending surface into contact with the first and second materials on the surface of the first material carrier and moving the first blending surface relative to the surface of the first material carrier also transfers the layers of first and second material on to the common blending surface.

85. A method according to claim 82, wherein the first material carrier and the second material carrier are separate and wherein the method further comprises transferring the layer of first material and the layer of second material to a surface of a common material carrier such that the first and second layers of material overlap in a region corresponding to the blended material region.

86. A method according to claim 85, wherein the surface of the common material carrier acts as the first blending surface and the second blending surface such that the method comprises bringing the surface of common material carrier into contact with the first material on the surface of the first material carrier and moving the surface of common material carrier relative to the surface of the first material carrier and transferring the layer of first material on to the surface of common material carrier, and bringing the surface of common material carrier into contact with the second material on the surface of the second material carrier and transferring the layer of second material on to the surface of common material carrier such that the first and second layers of material overlap in a region corresponding to the blended material region.

87. A method according to claim 82, wherein moving the first and/or second blending surface relative to the first and/or second material carrier comprises reciprocating the first and/or second blending surface relative to the first and/or second material carrier along the first direction.

88. A method according to claim 82, wherein the or each surface is the surface of a roller and wherein the method is a continuous inline process.

89. A method according to claim 83, wherein the first region is adjacent or spaced from the second region on the surface of the common material carrier such that the first and second materials do not overlap on the surface of the first material carrier before blending.

90. A method according to claim 82, wherein the first and second regions of the layers of first and second materials are applied to first and second material carriers using a material application system, the material application system comprising a first material duct arranged to provide the first region of the layer of the first material, and a second material duct arranged to provide the second region of the layer of second material.

91. A method according to claim 82, wherein the first and second materials have different optical properties.

92. A method according to claim 82, wherein at least one microimage element of the array of microimage elements has a smallest lateral dimension of 100 μm or less.

93. A method according to claim 82, wherein the array of microimage elements comprises an array of elongate image strips.

94. A method according to claim 93, wherein the array of elongate image strips comprises a first set of elongate image strips, each defining a corresponding portion of a first image, and a second set of elongate image strip positions, the first set of elongate image strips being interlaced with the second set of elongate image strip positions.

95. A method according to claim 93, wherein the elongate image strips extend substantially along the first direction such that the material composition of each elongate image strip is substantially constant along its length and such that the material composition of the elongate image strips changes gradually across the array of elongate image strips.

96. A method according to claim 93, wherein the elongate image strips extend substantially perpendicular to the first direction such that each image strip varies gradually in its material composition along its length.

97. A method according to claim 82, wherein the array of microimage elements is applied to an image element region of the support layer and further comprising applying a layer of a secondary material across the image element region of the support layer such that the layer of a secondary material is visible through gaps in the array of microimage elements.

98. A method of manufacturing a security device comprising:
forming an array of microimage elements that vary in their material composition in accordance with claim 82;
applying a corresponding array of sampling elements over the array of microimage elements.

99. A method according to claim 98, wherein the array of sampling elements cooperate with the array of microimage elements so as to exhibit at least one image that varies gradually in its appearance along the first direction.

100. A method according to claim 98, wherein the array of microimage elements are provided across at least two discrete security device regions, wherein, the discrete security device regions are offset from one another along the first direction.

101. A security device comprising:
an array of microimage elements formed of at least a first material and a second material, the microimage elements of the array being integrally registered with one another, wherein the material composition of the array of microimage elements varies across the array along a first direction such that the array of microimage elements exhibits a gradual change in relative concentration of the first and second materials along the first direction.
